(19) United States
(12) Patent Application Publication
(10) Pub. No.: US 2024/0242067 A1
(43) Pub. Date: Jul. 18, 2024

(54) OPTICAL NEURAL NETWORK ACCELERATOR

(71) Applicant: Intel Corporation, Santa Clara, CA (US)

(72) Inventors: Songtao Liu, Santa Clara, CA (US); Haisheng Rong, Pleasanton, CA (US); Mozhgan Mansuri, Portland, OR (US); Ram Krishnamurthy, Portland, OR (US)

(21) Appl. No.: 18/621,802

(22) Filed: Mar. 29, 2024

(51) Int. Cl. G06N 3/067

(52) U.S. Cl. CPC G06N 3/067

(57) ABSTRACT

Systems, apparatuses and methods include technology that executes, with a first plurality of panels, a first matrix-matrix multiplication operation of a first layer of an optical neural network (ONN) to generate output optical signals based on input optical signals that pass through an optical path of the ONN, and weights of the first layer of the ONN. The first plurality of panels includes an input panel, a weight panel and a photodetector panel. The executing includes generating, with the input panel, the input optical signals, where the input optical signals represent an input to the first matrix-matrix multiplication operation of the first layer of the ONN, representing, with the weight panel, the weights of the first layer of the ONN, and generating, with the photodetector panel, output photodetector signals based on the output optical signals that are generated based on the input optical signals and the weights.

### BACKGROUND

Machine learning (e.g., neural networks, deep neural networks, etc.) workloads may include a significant amount of operations. For example, machine learning workloads may include numerous nodes that each execute different operations. Such operations may include General Matrix Multiply operations, multiply-accumulate operations, etc. The operations may consume memory and processing resources to execute.

### BRIEF DESCRIPTION OF THE DRAWINGS

The various advantages of the embodiments will become apparent to one skilled in the art by reading the following specification and appended claims, and by referencing the following drawings, in which:

FIGS. 1A-1C is an example of an 3D-integrated optical neural network (ONN) accelerator unit architecture according to an embodiment;

FIG. 2 is an example of an ONN compute pipeline according to an embodiment;

FIG. 3 is an example of an ONN compute pipeline according to an embodiment;

FIG. 3 is an example of a 3D dense package electro-optical structure according to an embodiment;

FIG. 4 is an example of a package electrical connection with adjacent computation architecture according to an embodiment;

FIG. 5 is a flowchart of an example of a method of performing optical calculations for an ONN according to an embodiment;

FIG. 6 is a diagram of an example of enhanced ONN computing system according to an embodiment;

FIG. 7 is an illustration of an example of a semiconductor apparatus according to an embodiment;

FIG. 8 is a block diagram of an example of a processor according to an embodiment; and

FIG. 9 is a block diagram of an example of a multi-processor based computing system according to an embodiment.

### DESCRIPTION OF EMBODIMENTS

Existing graphics processing units (GPUs) or Application-Specific Integrated Circuits (ASICs) may have energy efficiency (e.g., as measured as the energy consumption per operation (OP)) in the range of 0.5 to 1 petajoule (pJ) per operation. Further, the compute density (e.g., the number of operations per second for a given chip area) may be limited by the wire capacitance of electronic interconnects. Certain compute-in-memory architectures may achieve higher energy efficiency, however the compute density is lower and the precision is lower as well (e.g., binary, ternary, 2-4 bits). Therefore, GPUs and ASICs may have sub-optimal energy efficiency, precision and compute density.

Photonics may alleviate the aforementioned bottlenecks of compute and energy due to a large optical bandwidth and low loss data transmission properties, (e.g., obtain a high energy efficiency while maintaining a high compute density). Existing silicon integrated photonics-based neural networks accelerator examples (e.g., wavelength division multiplexing based accelerators, wavelength accelerators and/or time division multiplexing based accelerators, etc.), are limited by the high energy consumption due to low electro-optic conversion efficiency (e.g., light sources, electro-optic modulators, high speed photodetectors (PDs), high speed electronic drivers etc.). Further, existing examples include low compute density resulting from large component footprints and channel crosstalk (thermal crosstalk especially, so certain isolation spacing is required), and long latency due to the lack of inline optical nonlinearity.

Other existing optical designs include a free space integrated strategy to attempt to obtain a high energy efficiency and high compute density ONN accelerator. Such existing optical designs include a high energy efficient vertical-cavity surface-emitting laser (VCSEL) array, a leader laser to coherently lock all the VCSELs, as well as focal lenses and diffractive optical elements (DOEs) for aligning and input data copying, an integrated photodetector array for realizing inline optical nonlinearity and matrix calculation. Multiply-accumulate (MAC) data may be stored in the memory and sampled for a next layer. However, such existing optical designs are also sub-optimal from several technical perspectives.

Firstly, the existing optical designs may include a leader laser to coherently lock all the VCSELs by using a DOE and collimating lenses to realize the inline optical nonlinearity at the PD using a homodyning detection method. The homodyning detection method detrimentally relies on precise alignment and consumes extra power and space. Secondly, the VCSEL, used as the data input, also needs a DOE to form the exact same number of copies and lenses combination to align the input signal with the VCSELs (which may represent weights). Doing so detrimentally impacts density, which makes a dense 3D package difficult to obtain. Thirdly, the coherent locking of the VCSELs has a potential computing accuracy of 98% (e.g., 6 bits of precision), which is impacted by the phase instability of the set-up and the frequency instability of the injection locked VCSELs. Fourthly, based on the above, the scalability and reliability of the whole system is limited. Thus, existing optical designs have sub-optimal designs and performance (e.g., high energy consumption, significant space consumption, low compute density, channel crosstalk, inaccuracy, complicated and unreliable designs, etc.).

Enhanced examples as described herein may remedy at least some of the aforementioned sub-optimal designs and performance. In detail, enhanced examples described herein include a first plurality of panels that execute a matrix-matrix multiplication operation of a first layer of an optical neural network (ONN) to generate output optical signals based on input optical signals that pass through an optical path of the ONN, and weights of the first layer of the ONN. The first plurality of panels includes an input panel, a weight panel and a photodetector panel. The input panel generates the input optical signals, where the input optical signals represent an input to the matrix-matrix multiplication operation of the first layer of the ONN. The weight panel represents the weights of the first layer of the ONN, and the photodetector panel generates output photodetector signals based on the output optical signals that are generated based on the input optical signals and the weights. Enhanced examples may enhance the ONN accelerator performance, which may lead to faster processing speeds, increased efficiency, and increased compute density. Enhanced examples include a unique and innovative photonics neural network accelerator solution, which favors high-speed, high-energy efficiency, high compute density and scalability. Enhanced examples may therefore include high efficiency and high-density ONN accelerators.

Enhanced examples as described herein may include a 3D integrated discrete photonics as part of an ONN accelerator. The ONN accelerator may increase energy efficiency and computational density. Examples may be used in many different applications, including for speech recognition, image processing, visual quality enhancements and/or multi-streaming applications. The enhanced examples may perform high dimensional matrix-matrix multiplications in parallel. The enhanced examples incorporate several different features, including a highly scalable surface emitting semiconductor laser (SESL) array (e.g., VCSELs and/oor Photonic Crystal Surface-emitting Lasers (PCSELs)) with integrated collimating lenses that scale to significant dimensions, with high modulation speed and increased energy efficiency (e.g., electrical power to optical power conversion efficiency). The SESL array of the enhanced examples herein may be split into different input tiles with corresponding weight tiles in the optical path (from the kernel panel), which comprises inherent inline optical nonlinearity through voltage-controlled semiconductor saturable absorber-based nonlinear elements.

The ONN as described herein may include panels that are divided into tiles. A matrix-matrix multiplication operation may be decomposed into matrix-vector operations. The matrix-vector operations may be the equivalent of the matrix-matrix multiplication operation. The tiles may execute the matrix-vector operations. Each of the tiles may include an input portion of an input panel of the panels, a weight portion of a weight panel and a photodetector portion of a photodetector panel of the panels. Input optical signals (e.g., representing encoded vector data as light), is generated with the input portion (e.g., VCSEL) of a tile of the tiles and passes through each element in a corresponding weight portion of the weight panel. Doing so automatically realizes vector-element multiplication and the data will then be transmitted to a PD portion of the PD panel associated with the tile. The PD portion may generate photocurrents (e.g., electrical signals). Vector-vector multiplication data may be performed by summing all the generated photocurrents form the PD tile. Matrix-matrix multiplication is realized with the different tiles performing the matrix-vector operations and the resulting data may be stored to a memory for a following layer of the ONN.

The enhanced examples adapt to scalability, reliability, and the capacity for large-scale manufacturing. Enhanced examples also achieve a high compute density while maintaining a low energy consumption. Further, examples may have enhanced accuracy while avoiding

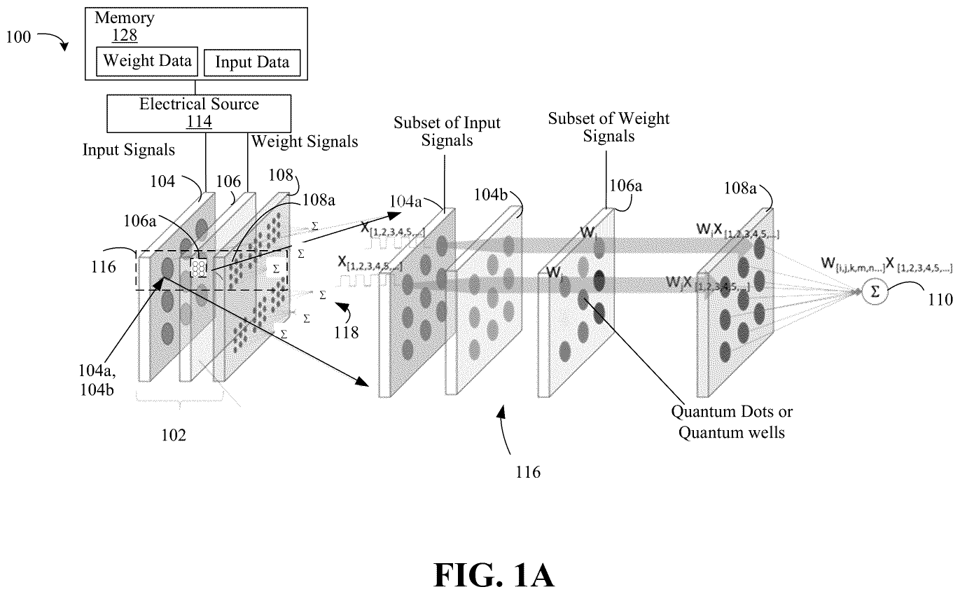

FIG. 1A illustrates a 3D-integrated ONN accelerator unit architecture 100. The 3D-integrated ONN accelerator unit architecture 100 executes matrix-matrix multiplication operations with a light-based operation as described below. The 3D-integrated ONN accelerator unit architecture 100 includes an ONN discrete photonics subsystem.

The 3D-integrated ONN accelerator unit architecture 100 may be an ONN that includes several layers. The layers may correspond to neurons of a neural network. In this example, a first layer 102 of the ONN is shown in detail. It will be understood that other layers similar to the first layer 102 may be included in the ONN, where the other layers execute matrix-matrix operations of the ONN. The first layer 102 may include an optical path.

The first layer 102 may execute a matrix-matrix multiplication operation. The matrix-matrix multiplication operation may be formed of matrix-vector operations that are independently performed.

For example, the first layer 102 may be composed of tiles. The tiles may execute different matrix-vector multiplication operations that form the matrix-matrix operation. The tiles may execute the different matrix-vector multiplication operations in parallel with one another. The tiles may each include a different portion of the first layer 102 as will be described below.

The first layer 102 contains a SESL panel 104 that generates input optical signals. The first layer 102 may include a quantum well or quantum dot material that emits light when excited by electrical signals (e.g., current). In detail, a memory 128 may store input data. The input data may be inputs to a neural network (e.g., an input matrix comprising input X_{[1, 2, 3, 4, 5, . . . ][a, b, c, d, e, . . . ]}). An electrical source 114 (e.g., digital-to-analog converter) may generate input signals based on the input X_{[1, 2, 3, 4, 5, . . . ][a, b, c, d, e, . . . ]}. For example, a digital-to-analog converter of the electrical source 114 may convert the input X_{[1, 2, 3, 4, 5, . . . ][a, b, c, d, e, . . . ]} of the input data into input signals (e.g., currents) that are applied to the SESL panel 104 and cause the SESL panel 104 to generate the input optical signals. For example, the quantum well or quantum dot material may be excited by the input signals causing the quantum well or quantum dot material to emit the input optical signals vertically (e.g., perpendicularly) to the surface.

The input optical signals may represent the input data, and/or an input to the matrix-matrix multiplication operation. The input data may be an input into a machine learning operation (e.g., neural network operation). For example, the input optical signals may represent the input X_{[1, 2, 3, 4, 5, . . . ][a, b, c, d, e, . . . ]}. The input X_{[1, 2, 3, 4, 5, . . . ][a, b, c, d, e, . . . ]} may be a matrix. The input optical signals may be divided into rays that each represent a different portion of the input X_{[1, 2, 3, 4, 5, . . . ][a, b, c, d, e, . . . ]}. For example, a first ray may represent X_{[1]}, a second ray may represent X_{[2]} and so on.

The SESL panel 104 may further includes a collimating panel. The collimating panel focuses the input optical signals and adjusts the direction of the input to transmit the input optical signals along an optical path to focus the input optical signals on portions of a weight panel 106 of the first layer 102. The collimating layer comprises integrated collimating lenses

As noted, the first layer 102 further includes the weight panel 106 (e.g., a kernel panel). The weight panel 106 represents weight values obtained from a pre-trained machine learning model. The memory 128 may store weight data that corresponds to the weight values of the ONN. The electrical source 114 may generate weight signals based on the weight data so that the photodetector panel 108 represents the weight values. The weight panel 106 may contain the same amount of weight tiles (e.g., 5×5, 10×10, 20×20, etc.) as the SESL panel 104. In some examples, the weight panel 106 may further represent biases of the multiplication-multiplication operation in addition to the weights.

The weight panel 106 may be made of the same semiconductor material system as SESL panel 104 (quantum well or quantum dot material based). Each element (e.g., quantum well or quantum dot) in the weight panel 106 may be voltage reverse bias controlled. The element is adjustable based on the voltage to enable different nonlinear absorption coefficients, as shown in FIG. 1B. The transparency of the element may be adjusted based on the voltage. For example, as the voltage increases, the transparency of the element decreases. Thus, a different voltage may be applied to each of the quantum dots and/or quantum wells with the weight signals to granularly control the transparency of the quantum dots and/or quantum wells. The quantum dots and/or quantum wells may be adjusted based on the different voltages of the weight signals to represent the different weights. The input optical signals generated by the SESL panel 104 is thus modulated with the weight panel 106 as the input optical signals passes through the weight panel 106 and is attenuated and/or transmitted based on the transparencies of the weight panel 106. The weight panel 106 may therefore generate modulated light based on the input optical signals.

The modulated light (e.g., vector-element calculation data that is represented by light intensity) from the weight panel 106 is then provided to photodetector panel 108 along the optical path. The photodetector panel 108 may convert the modulated input optical signals (may be referred to as output optical signals) into electrical energy. The output optical signals may be the output of a matrix-matrix operation that is executed with the input optical signals and the weights.

That is, the photodetector panel 108 may include photodetectors that convert the output optical signals (e.g., light and/or other electromagnetic radiation) into electrical signals (e.g., a photocurrent). The output photodetector signals may be the electrical signals. Thus, the output photodetector signals correspond to the output optical signals. Accumulators 118 (e.g., capacitors) may receive the output photodetector signals (e.g., electrical signals) from the photodetector panel 108. The accumulators 118 may then sum the output photodetector signals (e.g., per Kirchoff's current law) to generate output electrical signals (e.g., analog signals). Further, the output electrical signals may be stored into the memory 128 (e.g., via an analog-to-digital converter) as further input data for a second layer of the ONN (not shown). The second layer (not shown) of the ONN may access the data to execute further operations (e.g., matrix-matrix multiplication operation).

As noted above, the first layer 102 may be divided into tiles. In some examples, the tiles each include a portion of the SESL panel 104, weight panel 106, photodetector panel 108 and accumulators 118 (e.g., capacitors).

For example, a tile 116 is illustrated in further detail in FIG. 1A. It will be understood that the first layer 102 may include many tiles that are similarly constructed to the tile 116. The tile 116 includes a first SESL tile 104a, an integrated collimating lenses tile 104b, a weight tile 106a and an integration PD tile 108a.

In this example, the tile 116 executes a first vector-vector operation. The first vector-vector operation may be a part of the matrix-matrix operation. In this example, the first SESL tile 104a generates vector optical signals (e.g., light) based on a subset of the input signals. The vector optical signals have intensities that correspond to the input vector X_{[1, 2, 3, 4, 5, . . . ]} of the input matrix X_{[1, 2, 3, 4, 5, . . . ][a, b, c, d, e, . . . ]}. The electrical source 114 may provide the subset of input signals (e.g., electrical currents) to quantum dots of the first SESL tile 104a to cause the first SESL tile 104a to generate the vector optical signals.

The vector optical signals are then provided to the integrated collimating lenses tile 104b. The integrated collimating lenses tile 104b receives the vector optical signals and directs the vector optical signals to the weight tile 106a. The electrical source 114 may provide a voltage to the weight tile 106a to control an opacity and/or transparency of the weight tile 106a. Different portions of the weight tile 106a may have different opacities. For example, a first portion may have a high transparency, a second portion may have a lower transparency, etc. The weight tile 106a may represent weights W_{[i, j, k, m, n, . . . ]}. The W_{[i, j, k, m, n, . . . ]} may be a weight vector.

Therefore, when the vector optical signals (e.g., light) of the first SESL tile 104a (e.g., modulated with input vector data X_{[1, 2, 3, 4, 5, . . . ]}) passes through the weight tile 106a, or through the transparencies representing the weights Wⱼ or Wₖ . . . , a vector-element calculation in automatically calculated (e.g., experience different absorption) with inline optical nonlinearity. That is, the opacity and/or transparency of the weight tile 106a automatically adjusts the intensities of the vector optical signals, causing the resulting output optical signal from the weight tile 106a to represent a vector-vector calculation between the weight vector and the vector optical signals. That is, inline optical nonlinearity may be obtained simultaneously since the absorption coefficient is dependent on the intensity of the vector optical signals and the weights represented by the weight tile 106a.

That is, the vector-vector calculation may be done automatically by the whole weight tile 106a. The vector-element calculation data (light intensity) will be read out by the PDs in the PD tile 108a and converted to electrical energy.

An accumulator 110 of the accumulators 118 may sum the outputs (e.g., electrical energy) of the PDs of the PD tile 108a to obtain the vector-vector calculation data (X_{[1, 2, 3, 4, 5, . . . ]}*W_{[i, j, k, m, n, . . . ]}), which may be stored to the memory 128 as the input for next layer (not illustrated). Other tiles may similarly execute different vector-vector operations that compose the matrix-matrix operations.

A matrix-matrix calculation (e.g., X_{[1, 2, 3, 4, 5, . . . ][a, b, c, d, e, . . . ]}*W_{[i, j, k, m, n, . . . ][1, 2, 3, 4, 5, . . . ]}) may be executed by the SESL panel 104, weight panel 106 and photodetector panel 108, and based on the vector-vector operations executed with tiles of the SESL panel 104, weight panel 106, and photodetector panel 108. The outputs of the different tiles may be accumulated with accumulators 118 (e.g., capacitors) and then stored into memory 128.

For example, PD tile 108a of the tile 116 may receive output optical signals from the weight tile 106a. The PD tile 108a may generate output photodetector signals based on the output optical signals. For example, the PD tile 108a may include photodetectors that convert the output optical signals (e.g., light and/or other electromagnetic radiation) into electrical signals (e.g., a photocurrent). The output photodetector signals may be the electrical signals. Thus, the output photodetector signals correspond to the output optical signals. The accumulator 110 (e.g., capacitor) may receive the output photodetector signals (e.g., electrical signals) from the PD tile 108a. The accumulator 110 may then sum the output photodetector signals to generate an output electrical signal(s) (e.g., an analog signal). Further, the output electrical signals may be stored into a memory as data (e.g., via an analog-to-digital converter). A second layer (not shown) of the ONN may access the data to execute operations.

The enhanced examples described herein are not bound to the locking issues mentioned in existing examples. Further, enhanced examples as described herein obtain higher accuracy larger than 6 bits with floating point computation, which is sufficient for a wide range of domain-specific machine learning tasks.

FIG. 1B illustrates a saturable absorber absorption curve 120 of a quantum dot or quantum well of the weight panel 106. In this example, as the input power (in arbitrary units or a.u.) to the quantum dot or quantum well increases, the transmission increases (in arbitrary units or a.u.). As shown in the curve 124, different input powers will experience different absorption coefficients, which may be controlled by voltage.

FIG. 1C illustrates a transmission to voltage relationship 122 of a quantum dot or quantum well of the weight panel 106. As the voltage increases (in a.u.), the transmissibility decreases (in a.u.). Thus, the voltage to the quantum dot or the quantum well may be adjusted to control transmission of optical signals. The electrical source 114 may provide discrete voltages to quantum dots or quantum wells of the weight panel 106.

In some examples, the 3D-integrated ONN accelerator unit architecture 100 is part of an inference process. In such an example, the weight signals to the weight tile 106a may be maintained throughout different inference operations. In some examples, the 3D-integrated ONN accelerator unit architecture 100 is part of a training process of the ONN. In such an example, the weight signals to the weight tile 106a may be adjusted during different iterations of the training process. In some examples, the photodetector panel 108, and/or electrical source 114 (e.g., an analog-to-digital converter and digital-to-analog converter) may be shared by a computing unit, so that the consumed power may also be amortized to each operation, leading to overall energy per operation saving.

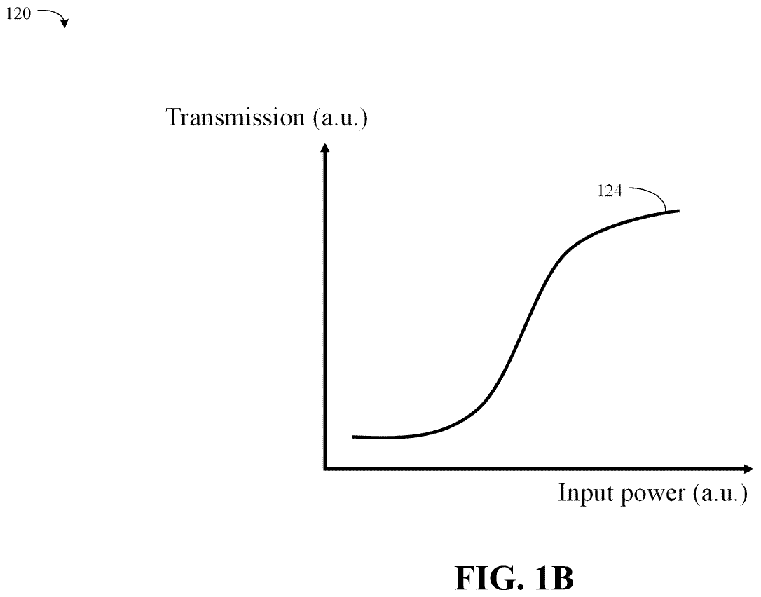

FIG. 2 illustrates an ONN compute pipeline 130. The ONN compute pipeline 130 may generally be implemented with the embodiments described herein, for example, the 3D-integrated ONN accelerator unit architecture 100 (FIGS. 1A-IC) already described. In this example, a first layer of the ONN compute pipeline 130 includes a first SESL panel 132, first weight panel 134, photodetector panel 136 and accumulators 154. The first layer may execute a matrix-matrix operation as described above to generate output optical signals. For example, the first layer may be divided into tiles that perform different vector-vector multiplication operations of the matrix-matrix multiplication operation. Output electrical signals from the photodetector panel 136 may be accumulated with the accumulators 154. Each of the accumulators 154 may store an output of one of the different vector-vector multiplication operations in an analog format.

The outputs of the accumulators 154 may be provided to an analog-to-digital converter 138 that converts the analog signal, representing output optical signals, to digital signals to be stored into memory 140. The memory 140 may provide the digital signals to a digital-to-analog converter 142.

A second layer of the ONN compute pipeline 130 may then receive the analog signals from the digital-to-analog converter 142 to cause a second SESL panel 144 to generate input optical signals. The input optical signals are then modulated with a second weight panel 146 of the second layer. A photodetector panel 148 of the second layer then receives the modulated input optical signals (output optical signals) and generates output electrical signals (e.g., analog signals) that are provided accumulators 156 that sum the output electrical signals of the different tiles.

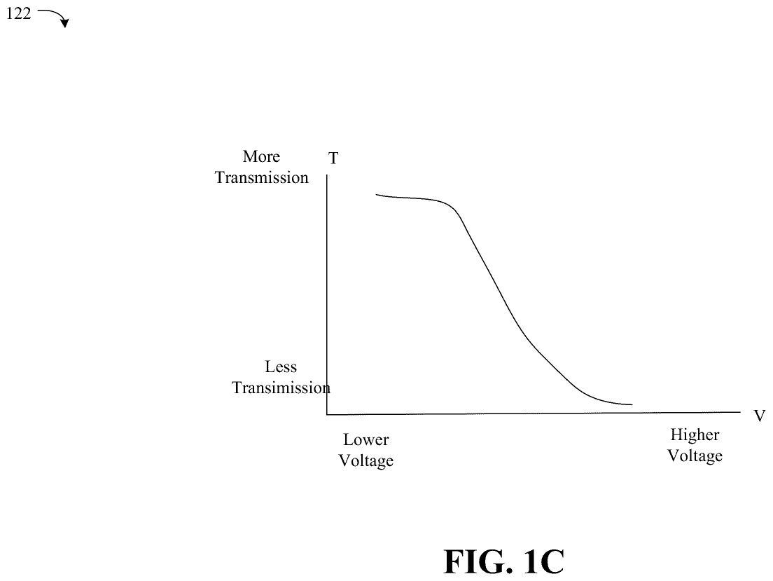

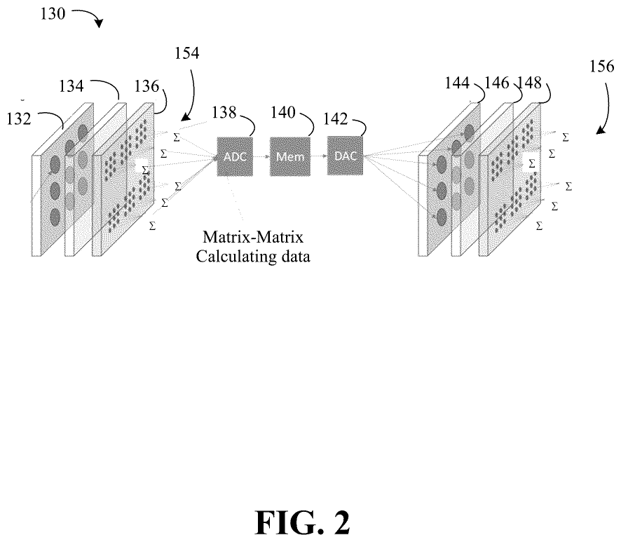

Turning now to FIG. 3, a 3D dense package electro-optical structure 180 is illustrated. The 3D dense package electro-optical structure 180 includes a first electronics panel 182 (e.g., ADC, memory, DAC, etc.). The dense package electro-optical structure 180 includes an integration PD panel 184, a weight panel 186, a SESL panel 188 with integrated collimating lenses, a handling substrate 190 and a second electronics panel 192 (e.g., ADC, memory, DAC, etc.). The 3D dense package electro-optical structure 180 may generally be implemented with the embodiments described herein, for example, the 3D-integrated ONN accelerator unit architecture 100 (FIGS. 1A-1C) and/or ONN compute pipeline 130 (FIG. 2) already described.

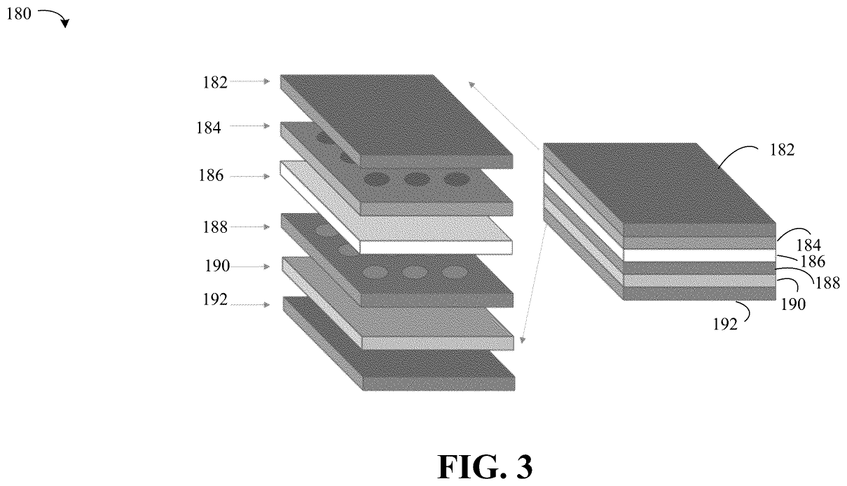

FIG. 4 illustrates a package electrical connection with adjacent computation architecture 160. Particle Circuit Boards 162, 164 support a first layer 170, a second layer 168 and a third layer 166 of an ONN. Electrical interconnects 172, 174 connect the first layer 170, the second layer 168 and the third layer 166 for data exchange. package electrical connection with adjacent computation architecture 160 The package electrical connection with adjacent computation architecture 160 may generally be implemented with the embodiments described herein, for example, the 3D-integrated ONN accelerator unit architecture 100 (FIGS. 1A-1C), ONN compute pipeline 130 (FIG. 2) and/or 3D dense package electro-optical structure 180 (FIG. 3) already described.

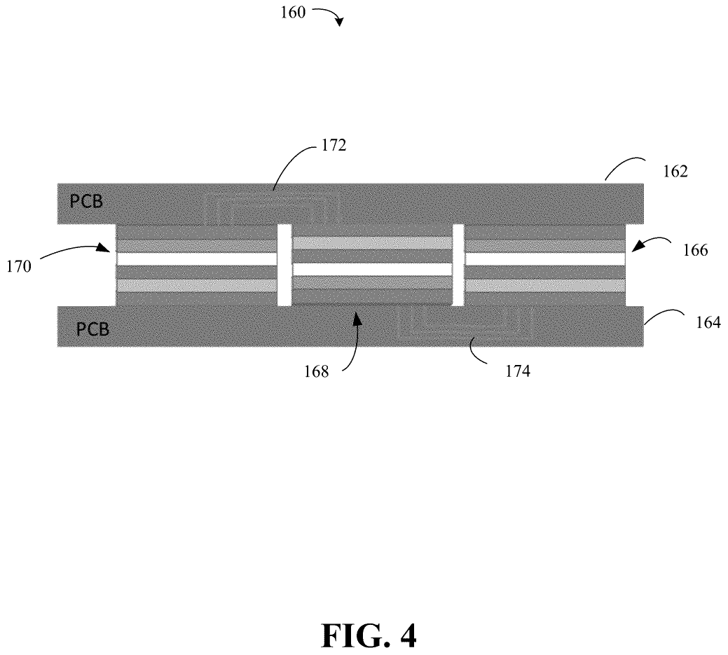

Turning now to FIG. 5, a method 400 of performing optical calculations for an ONN in further detail. The method 400 may generally be implemented with the embodiments described herein, for example, the 3D-integrated ONN accelerator unit architecture 100 (FIGS. 1A-1C), ONN compute pipeline 130 (FIG. 2), 3D dense package electro-optical structure 180 (FIG. 3), and/or package electrical connection with adjacent computation architecture 160 (FIG. 4) already described. More particularly, method 400 may be implemented in one or more modules as a set of logic instructions stored in a RAM, ROM, PROM, firmware, flash memory, etc., in hardware, or any combination thereof. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, general purpose microprocessor or combinational logic circuits, and sequential logic circuits or any combination thereof. The configurable or fixed-functionality logic can be implemented with CMOS logic circuits, TTL logic circuits, or other circuits.

For example, computer program code to carry out operations shown in the device owner marking method 400 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 402 includes executing, with a first plurality of panels, a first matrix-matrix multiplication operation of a first layer of ONN to generate output optical signals based on input optical signals that pass through an optical path of the ONN, and weights of the first layer of the ONN, where the first plurality of panels includes an input panel, a weight panel and a photodetector panel. The executing comprises generating, with the input panel, the input optical signals, where the input optical signals represent an input to the first matrix-matrix multiplication operation of the first layer of the ONN. The executing further comprises representing, with the weight panel, the weights of the first layer of the ONN, and generating, with the photodetector panel, output photodetector signals based on the output optical signals that are generated based on the input optical signals and the weights. Illustrated processing block 404 includes executing, with a second layer of the ONN that comprises a second plurality of panels, a second matrix-matrix multiplication operation.

In some examples, the method 400 includes focusing, with a collimating panel of the input panel, the input optical signals onto the weight panel through the optical path. In some examples, the method 400 includes supplying, with an electrical source, voltages to the weight panel based on the weights, and adjusting transparencies of the weight panel based on the voltages, wherein the transparencies correspond to the weights. In some examples, the method 400 includes dividing the input panel, the weight panel and the photodetector panel into tiles that perform different vector-vector multiplication operations of the first matrix-matrix multiplication operation. In some examples, the method 400 includes generating, with the input panel, the input optical signals based on stored data that corresponds to the input into the first matrix-matrix multiplication operation. In some examples, the method 400 includes summing the output photodetector signals to generate output electrical signals, storing data based on the output electrical signals into a memory, receiving, with the second plurality of panels, the data from the memory and generating, with the second plurality of panels, input optical signals based on the data for the second matrix-matrix multiplication operation.

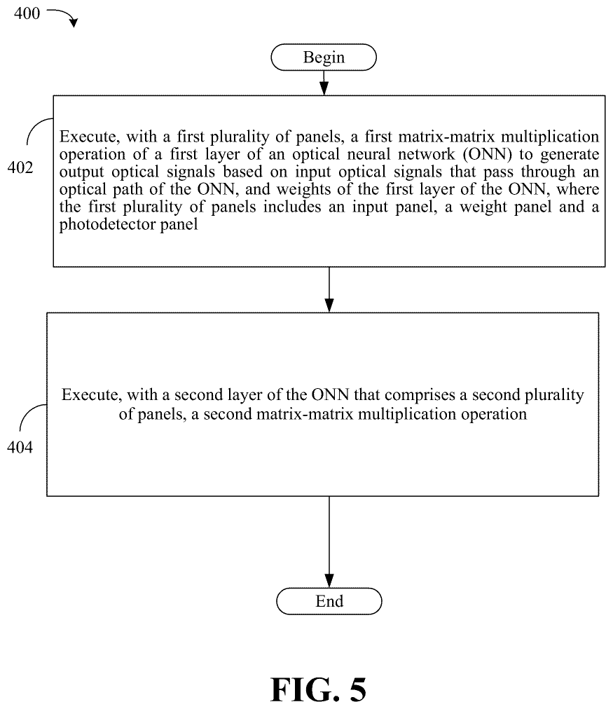

Turning now to FIG. 6, an enhanced ONN computing system 600 is shown. The computation enhanced ONN computing system 600 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot, manufacturing robot, autonomous vehicle, industrial robot, etc.), edge device (e.g., mobile phone, desktop, etc.) etc., or any combination thereof. In the illustrated example, the computing system 600 includes a host processor 608 (e.g., CPU) having an integrated memory controller (IMC) 610 that is coupled to a system memory 612.

The illustrated computing system 600 also includes an input output (IO) module 620 implemented together with the host processor 608, the graphics processor 606 (e.g., GPU), ROM 622, and AI optical accelerator 602 on a semiconductor die 604 as a system on chip (SoC). The illustrated IO module 620 communicates with, for example, a display 616 (e.g., touch screen, liquid crystal display/LCD, light emitting diode/LED display), a network controller 628 (e.g., wired and/or wireless), FPGA 624 and mass storage 626 (e.g., hard disk drive/HDD, optical disk, solid state drive/SSD, flash memory). The IO module 620 also communicates with sensors 618 (e.g., video sensors, audio sensors, proximity sensors, heat sensors, etc.).

The SoC 604 may further include processors (not shown) and/or the AI optical accelerator 602 dedicated to artificial intelligence (AI) and/or neural network (NN) processing. For example, the SoC 604 may include vision processing units (VPUs,) and/or other AI/NN-specific processors such as the AI optical accelerator 602, etc. In some embodiments, any aspect of the embodiments described herein may be implemented in the processors, such as the graphics processor 606 and/or the host processor 608, and in the accelerators dedicated to AI and/or NN processing such as AI optical accelerator 602 or other devices such as the FPGA 624. In this particular example, the AI optical accelerator 602 may implement an ONN having multiple layers. For example, the AI optical accelerator 602 may access the system memory 612 to obtain weight data 630 and input data 632 via electronic devices 634 (e.g., analog-to-digital converters and digital-to-analog converters) to execute a matrix-matrix multiplication operation of a layer of the ONN.

The graphics processor 606, AI optical accelerator 602 and/or the host processor 608 may execute instructions 614 retrieved from the system memory 612 (e.g., a dynamic random-access memory) and/or the mass storage 626 to implement aspects as described herein. In some examples, when the instructions 614 are executed, the enhanced ONN computing system 600 may implement one or more aspects of the embodiments described herein. For example, the enhanced ONN computing system 600 may generally be implemented with the embodiments described herein, for example, the 3D-integrated ONN accelerator unit architecture 100 (FIGS. 1A-1C), ONN compute pipeline 130 (FIG. 2), 3D dense package electro-optical structure 180 (FIG. 3), package electrical connection with adjacent computation architecture 160 (FIG. 4) and/or method 400 (FIG. 5) already discussed.

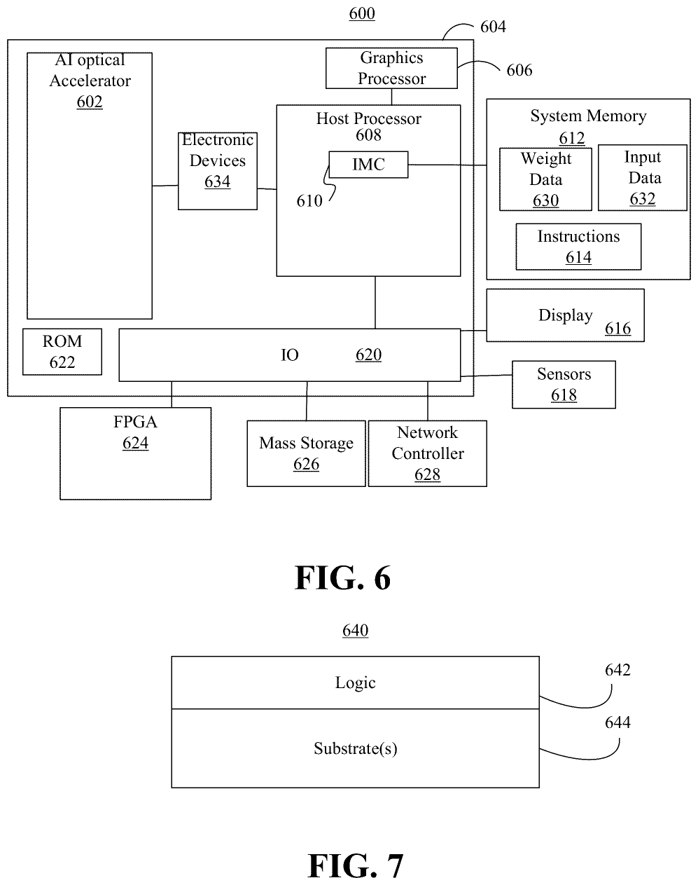

FIG. 7 shows a semiconductor apparatus 640 (e.g., chip, die, package). The illustrated apparatus 640 includes one or more substrates 644 (e.g., silicon, sapphire, gallium arsenide) and logic 642 (e.g., transistor array and other integrated circuit/IC components) coupled to the substrate(s) 644. In an embodiment, the apparatus 640 is operated in an application development stage and the logic 642 performs one or more aspects of the embodiments described herein. For example, the 3D-integrated ONN accelerator unit architecture 100 (FIGS. 1A-IC), ONN compute pipeline 130 (FIG. 2), 3D dense package electro-optical structure 180 (FIG. 3), package electrical connection with adjacent computation architecture 160 (FIG. 4) and/or method 400 (FIG. 5) already discussed. The logic 640 may be implemented at least partly in configurable logic or fixed-functionality hardware logic. In one example, the logic 642 includes transistor channel regions that are positioned (e.g., embedded) within the substrate(s) 644. Thus, the interface between the logic 642 and the substrate(s) 644 may not be an abrupt junction. The logic 642 may also be considered to include an epitaxial layer that is grown on an initial wafer of the substrate(s) 644.

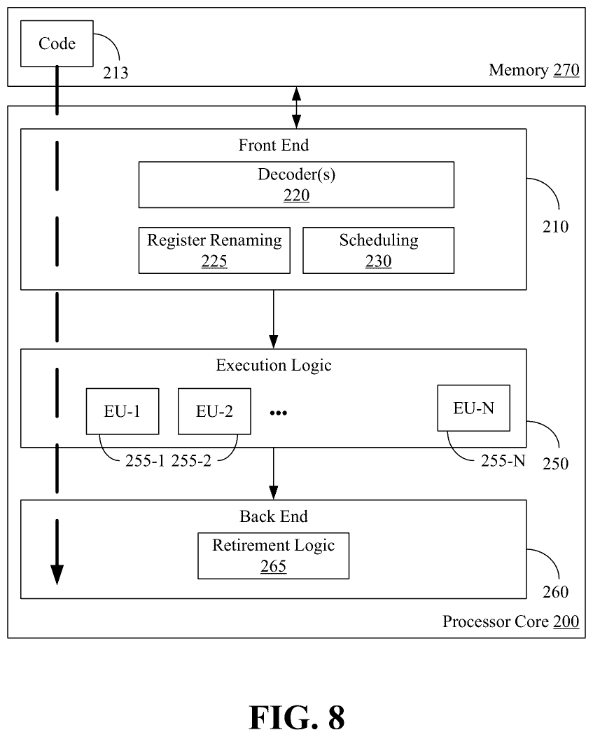

FIG. 8 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 8, a processing element may alternatively include more than one of the processor core 200 illustrated in FIG. 8. The processor core 200 may be a single-threaded core or, for at least one embodiment, the processor core 200 may be multithreaded in that it may include more than one hardware thread context (or “logical processor”) per core.

FIG. 8 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, the 3D-integrated ONN accelerator unit architecture 100 (FIGS. 1A-IC), ONN compute pipeline 130 (FIG. 2), 3D dense package electro-optical structure 180 (FIG. 3), package electrical connection with adjacent computation architecture 160 (FIG. 4) and/or method 400 (FIG. 5) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include several execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 8, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

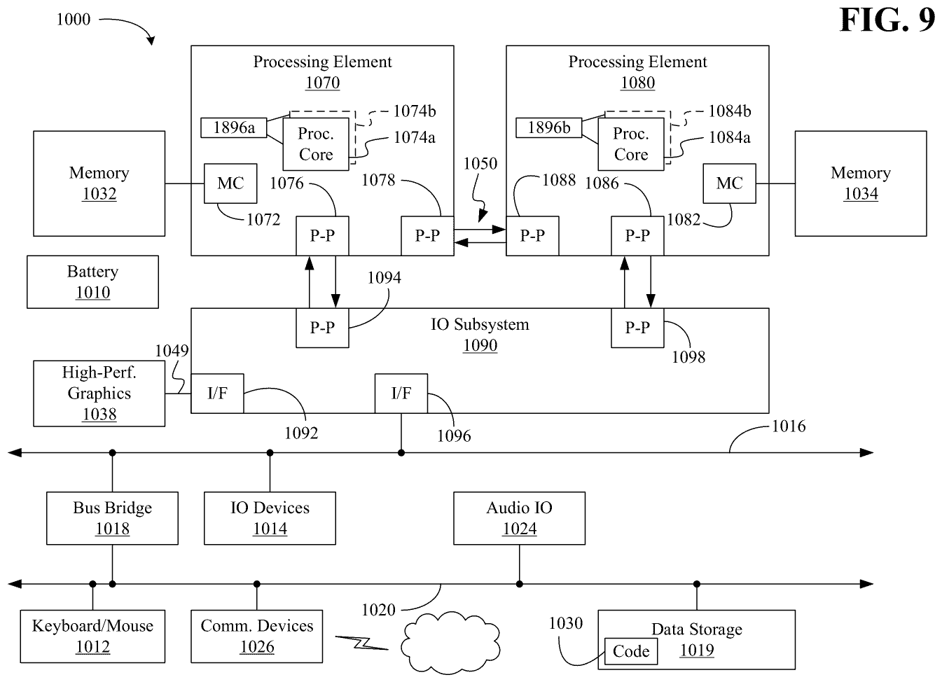

Referring now to FIG. 9, shown is a block diagram of a computing system 1000 embodiment in accordance with an embodiment. Shown in FIG. 9 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood any or all the interconnects illustrated in FIG. 9 may be implemented as a multi-drop bus rather than point-to-point interconnect.

As shown in FIG. 9, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner like that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 9, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 9, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 9, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the one or more aspects of such as, for example, the 3D-integrated ONN accelerator unit architecture 100 (FIGS. 1A-1C), ONN compute pipeline 130 (FIG. 2), 3D dense package electro-optical structure 180 (FIG. 3), package electrical connection with adjacent computation architecture 160 (FIG. 4) and/or method 400 (FIG. 5) already discussed. Further, an audio I/O 1024 may be coupled to second bus 1020 and a battery 1010 may supply power to the computing system 1000.

Note that other embodiments are contemplated. For example, instead of the point-to-point architecture of FIG. 9, a system may implement a multi-drop bus or another such communication topology. Also, the elements of FIG. 9 may alternatively be partitioned using more or fewer integrated chips than shown in FIG. 9.

### Additional Notes and Examples

Example 1 includes an apparatus comprising a substrate, and a first plurality of panels disposed on the substrate and that execute a matrix-matrix multiplication operation of a first layer of an optical neural network (ONN) to generate output optical signals based on input optical signals that pass through an optical path of the ONN, and weights of the first layer of the ONN, where the first plurality of panels includes an input panel, a weight panel and a photodetector panel, where the input panel generates the input optical signals, where the input optical signals represent an input to the matrix-matrix multiplication operation of the first layer of the ONN, the weight panel represents the weights of the first layer of the ONN, and the photodetector panel is to generate output photodetector signals based on the output optical signals that are generated based on the input optical signals and the weights.

Example 2 includes the apparatus of Example 1, where the input panel comprises a collimating panel that focuses the input optical signals onto the weight panel through the optical path.

Example 3 includes the apparatus of Example 1, further comprising an electrical source that is to supply voltages to the weight panel based on the weights, where the weight panel is to adjust transparencies of the weight panel based on the voltages, where the transparencies correspond to the weights.

Example 4 includes the apparatus of any one of Examples 1 to 3, where the input panel, the weight panel and the photodetector panel are divided into tiles that perform different vector-vector multiplication operations of the matrix-matrix multiplication operation.

Example 5 includes the apparatus of Example 1, where the input panel generates the input optical signals based on stored data that corresponds to the input into the matrix-matrix multiplication operation.

Example 6 includes the apparatus of any one of Examples 1 to 5, further comprising an accumulator that sums the output photodetector signals to generate output electrical signals, and a memory that stores data based on the output electrical signals.

Example 7 includes the apparatus of Example 6, further comprising a second plurality of panels that is to execute a matrix-matrix multiplication operation of a second layer of the ONN based on the data stored in the memory.

Example 8 includes an optical neural network (ONN) comprising a first layer that comprises a first plurality of panels that executes a first matrix-matrix multiplication operation to generate output optical signals based on input optical signals that pass through an optical path of the ONN, and weights of the first layer of the ONN, where the first plurality of panels includes an input panel, a weight panel and a photodetector panel, where the input panel generates the input optical signals, where the input optical signals represent an input to the first matrix-matrix multiplication operation of the first layer of the ONN, the weight panel represents the weights of the first layer of the ONN, and the photodetector panel is to generate output photodetector signals based on the output optical signals that are generated based on the input optical signals and the weights, and a second layer that comprises a second plurality of panels that execute a second matrix-matrix multiplication operation.

Example 9 includes the ONN of Example 8, where the input panel comprises a collimating panel that focuses the input optical signals onto the weight panel through the optical path.

Example 10 includes the ONN of Example 8, further comprising an electrical source that is to supply voltages to the weight panel based on the weights, where the weight panel is to adjust transparencies of the weight panel based on the voltages, where the transparencies correspond to the weights.

Example 11 includes the ONN of any one of Examples 8 to 10, where the input panel, the weight panel and the photodetector panel are divided into tiles that perform different vector-vector multiplication operations of the first matrix-matrix multiplication operation.

Example 12 includes the ONN of Example 8, where the input panel generates the input optical signals based on stored data that corresponds to the input into the first matrix-matrix multiplication operation.

Example 13 includes the ONN of any one of Examples 8 to 12, further comprising an accumulator that sums the output photodetector signals to generate output electrical signals, and a memory that stores data based on the output electrical signals.

Example 14 includes the ONN of Example 13, where the second plurality of panels is to receive the data from the memory and generate input optical signals based on the data for the second matrix-matrix multiplication operation.

Example 15 includes a method comprising executing, with a first plurality of panels, a first matrix-matrix multiplication operation of a first layer of an optical neural network (ONN) to generate output optical signals based on input optical signals that pass through an optical path of the ONN, and weights of the first layer of the ONN, where the first plurality of panels includes an input panel, a weight panel and a photodetector panel, where the executing comprises generating, with the input panel, the input optical signals, where the input optical signals represent an input to the first matrix-matrix multiplication operation of the first layer of the ONN, representing, with the weight panel, the weights of the first layer of the ONN, and generating, with the photodetector panel, output photodetector signals based on the output optical signals that are generated based on the input optical signals and the weights, and executing, with a second layer of the ONN that comprises a second plurality of panels, a second matrix-matrix multiplication operation.

Example 16 includes the method of Example 15, further comprising focusing, with a collimating panel of the input panel, the input optical signals onto the weight panel through the optical path.

Example 17 includes the method of Example 15, further comprising supplying, with an electrical source, voltages to the weight panel based on the weights, and adjusting transparencies of the weight panel based on the voltages, where the transparencies correspond to the weights.

Example 18 includes the method of any one of Examples 15 to 17, further comprising dividing the input panel, the weight panel and the photodetector panel into tiles that perform different vector-vector multiplication operations of the first matrix-matrix multiplication operation.

Example 19 includes the method of Example 15, further comprising generating, with the input panel, the input optical signals based on stored data that corresponds to the input into the first matrix-matrix multiplication operation.

Example 20 includes the method of any one of Examples 15 to 19, further comprising summing the output photodetector signals to generate output electrical signals, storing data based on the output electrical signals into a memory, receiving, with the second plurality of panels, the data from the memory, and generating, with the second plurality of panels, input optical signals based on the data for the second matrix-matrix multiplication operation.

Example 21 includes a means for executing any one of Examples 15 to 20.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical, or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An apparatus comprising:
a substrate; and
a first plurality of panels disposed on the substrate and that execute a matrix-matrix multiplication operation of a first layer of an optical neural network (ONN) to generate output optical signals based on input optical signals that pass through an optical path of the ONN, and weights of the first layer of the ONN, wherein the first plurality of panels includes an input panel, a weight panel and a photodetector panel, wherein
the input panel generates the input optical signals, wherein the input optical signals represent an input to the matrix-matrix multiplication operation of the first layer of the ONN,
the weight panel represents the weights of the first layer of the ONN, and
the photodetector panel is to generate output photodetector signals based on the output optical signals that are generated based on the input optical signals and the weights.

2. The apparatus of claim 1, wherein the input panel comprises a collimating panel that focuses the input optical signals onto the weight panel through the optical path.

3. The apparatus of claim 1, further comprising an electrical source that is to supply voltages to the weight panel based on the weights,
wherein the weight panel is to adjust transparencies of the weight panel based on the voltages, wherein the transparencies correspond to the weights.

4. The apparatus of claim 1, wherein the input panel, the weight panel and the photodetector panel are divided into tiles that perform different vector-vector multiplication operations of the matrix-matrix multiplication operation.

5. The apparatus of claim 1, wherein the input panel generates the input optical signals based on stored data that corresponds to the input into the matrix-matrix multiplication operation.

6. The apparatus of claim 1, further comprising:
an accumulator that sums the output photodetector signals to generate output electrical signals; and
a memory that stores data based on the output electrical signals.

7. The apparatus of claim 6, further comprising a second plurality of panels that is to execute a matrix-matrix multiplication operation of a second layer of the ONN based on the data stored in the memory.

8. An optical neural network (ONN) comprising:
a first layer that comprises a first plurality of panels that executes a first matrix-matrix multiplication operation to generate output optical signals based on input optical signals that pass through an optical path of the ONN, and weights of the first layer of the ONN, wherein the first plurality of panels includes an input panel, a weight panel and a photodetector panel, wherein
the input panel generates the input optical signals, wherein the input optical signals represent an input to the first matrix-matrix multiplication operation of the first layer of the ONN,
the weight panel represents the weights of the first layer of the ONN, and
the photodetector panel is to generate output photodetector signals based on the output optical signals that are generated based on the input optical signals and the weights; and
a second layer that comprises a second plurality of panels that execute a second matrix-matrix multiplication operation.

9. The ONN of claim 8, wherein the input panel comprises a collimating panel that focuses the input optical signals onto the weight panel through the optical path.

10. The ONN of claim 8, further comprising an electrical source that is to supply voltages to the weight panel based on the weights,
wherein the weight panel is to adjust transparencies of the weight panel based on the voltages, wherein the transparencies correspond to the weights.

11. The ONN of claim 8, wherein the input panel, the weight panel and the photodetector panel are divided into tiles that perform different vector-vector multiplication operations of the first matrix-matrix multiplication operation.

12. The ONN of claim 8, wherein the input panel generates the input optical signals based on stored data that corresponds to the input into the first matrix-matrix multiplication operation.

13. The ONN of claim 8, further comprising:
an accumulator that sums the output photodetector signals to generate output electrical signals; and
a memory that stores data based on the output electrical signals.

14. The ONN of claim 13, wherein the second plurality of panels is to receive the data from the memory and generate input optical signals based on the data for the second matrix-matrix multiplication operation.

15. A method comprising:
executing, with a first plurality of panels, a first matrix-matrix multiplication operation of a first layer of an optical neural network (ONN) to generate output optical signals based on input optical signals that pass through an optical path of the ONN, and weights of the first layer of the ONN, wherein the first plurality of panels includes an input panel, a weight panel and a photodetector panel, wherein the executing comprises:
generating, with the input panel, the input optical signals, wherein the input optical signals represent an input to the first matrix-matrix multiplication operation of the first layer of the ONN,
representing, with the weight panel, the weights of the first layer of the ONN, and
generating, with the photodetector panel, output photodetector signals based on the output optical signals that are generated based on the input optical signals and the weights; and
executing, with a second layer of the ONN that comprises a second plurality of panels, a second matrix-matrix multiplication operation.

16. The method of claim 15, further comprising focusing, with a collimating panel of the input panel, the input optical signals onto the weight panel through the optical path.

17. The method of claim 15, further comprising:
supplying, with an electrical source, voltages to the weight panel based on the weights; and
adjusting transparencies of the weight panel based on the voltages, wherein the transparencies correspond to the weights.

18. The method of claim 15, further comprising dividing the input panel, the weight panel and the photodetector panel into tiles that perform different vector-vector multiplication operations of the first matrix-matrix multiplication operation.

19. The method of claim 15, further comprising generating, with the input panel, the input optical signals based on stored data that corresponds to the input into the first matrix-matrix multiplication operation.

20. The method of claim 15, further comprising:
summing the output photodetector signals to generate output electrical signals;
storing data based on the output electrical signals into a memory;
receiving, with the second plurality of panels, the data from the memory; and
generating, with the second plurality of panels, input optical signals based on the data for the second matrix-matrix multiplication operation.
